(19) United States
(12) Patent Application Publication
(10) Pub. No.: US 2010/0037219 A1
(43) Pub. Date: Feb. 11, 2010

(54) PREDICTIVE LOGIC FOR AUTOMATIC WEB FORM COMPLETION

(75) Inventors: Danny Chen, Austin, TX (US); Ming Han Lee, Taipei City (TW); Ta-Wei Lin, Taipei (TW); Meng Li Wong, Taipei (TW)

Correspondence Address: DILLON & YUDELL LLP, 8911 N. CAPITAL OF TEXAS HWY.,, SUITE 2110, AUSTIN, TX, 78759, US

(73) Assignee: INTERNATIONAL BUISNESS MACHINES CORPORATION, Armonk, NY (US)

(21) Appl. No.: 12/186,324

(22) Filed: Aug. 5, 2008

(51) Int. Cl. G06F 17/00; G06F 9/445

(52) U.S. Cl. 717/176; 715/226; 715/224

(57) ABSTRACT

A method, system, and computer program product for autonomously completing a web form based on preferences and conditions established by a user. A predictive logic autonomously completes a web form by determining a requested data type of one or more form objects in the web form. The predictive logic determines a form preference corresponding to an identifier of a selected form object and selects or inserts data of the form preference into the form object. The form preference may be predefined by a user and stored within a form preference database which contains data selections and/or insertions for specific form objects for web forms. The form preference may also specify conditions for triggering events or actions of a web browser. The predictive logic monitors user insertions of a web form and prompts a user to define additional form preferences.

### BACKGROUND OF THE INVENTION

1. Technical Field

The present invention relates in general to computer logic. Still more particularly, the present invention relates to a predictive logic for autonomously completing web forms based on user defined preferences and conditions.

2. Description of the Related Art

When browsing on the Internet, especially on registration/shopping/download web sites, users are often prompted to perform selection on a form element, such as a checkbox, radio button or drop-down list, in order to indicate their preference. When a user is registering on a website, there are typically several form elements requesting general information of the user, each element requiring manual entry. Additionally, there may be license acceptance/agreement fields that a user must acknowledge in order to proceed to a subsequent page. HyperText markup language (HTML) pages may mandate users manually complete or select multiple form elements on each visit to that webpage. In most cases a user may not circumvent this manual interaction on a web site, which may inconvenience the user.

### SUMMARY OF THE INVENTION

Disclosed are a method, system, and computer program product for autonomously completing a web form based on preferences and conditions established by a user. A predictive logic autonomously completes a web form by determining a requested data type of one or more form objects in the web form. The predictive logic determines a form preference corresponding to an identifier of a selected form object and selects or inserts data of the form preference into the form object. The form preference may be predefined by a user and stored within a form preference database which contains data selections and/or insertions for specific form objects for web forms. The form preference may also specify conditions for triggering events or actions of a web browser, such as changing the display focus of the web browser or automatically clicking an acceptance element of a web form. The predictive logic monitors user insertions of a web form and prompts a user to define additional form preferences.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, will best be understood by reference to the following detailed descriptions of an illustrative embodiment when read in conjunction with the accompanying drawings, wherein:

FIG. 1 is a block diagram of a computer in which the present invention may be implemented; and

FIG. 2 is a block diagram of an exemplary system for autonomously completing a web form.

FIG. 3 is a block diagram of an exemplary user interface of a web form.

FIG. 4 is a block diagram of an exemplary user interface of a web form preview.

FIG. 5 is a high-level logical flowchart of an exemplary method for autonomously completing a web form.

### DETAILED DESCRIPTION OF THE PREFERRED EMBODIMENT

The illustrative embodiments provide a method, system, and computer program product for autonomously completing a web form based on preferences and conditions established by a user, in accordance with one embodiment of the invention.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized.

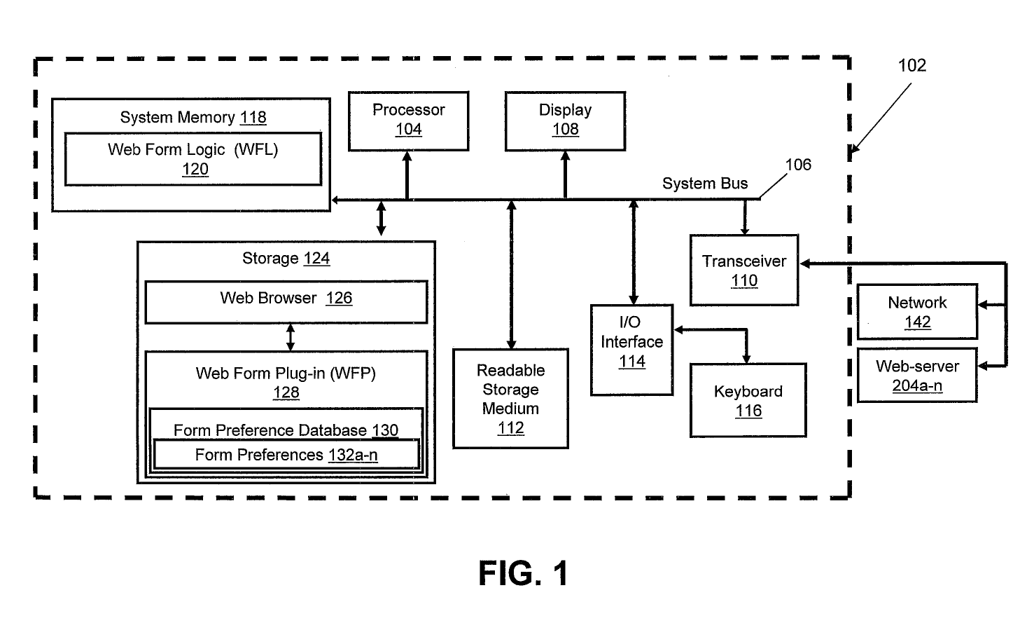

With reference now to FIG. 1, there is depicted a block diagram of a computer 102 in which the present invention may be implemented. Computer 102 includes a processor 104 that is coupled to a system bus 106. A transceiver 110, connected to system bus 106, enables computer 102 to connect to network 142 via wired or wireless mechanisms. Display 108, coupled to system bus 106, allows for presentation of a general user interface (including text and graphics) for use by a user of computer 102. System bus 106 also affords communication with a hardware-based readable storage medium 112 (e.g., Compact Disk-Read Only Memory (CD-ROM), flash drive memory, etc). Input/Output (I/O) Interface 114, also connected to system bus 106, and permits user interaction with computer 102, such as data entry via keyboard 116.

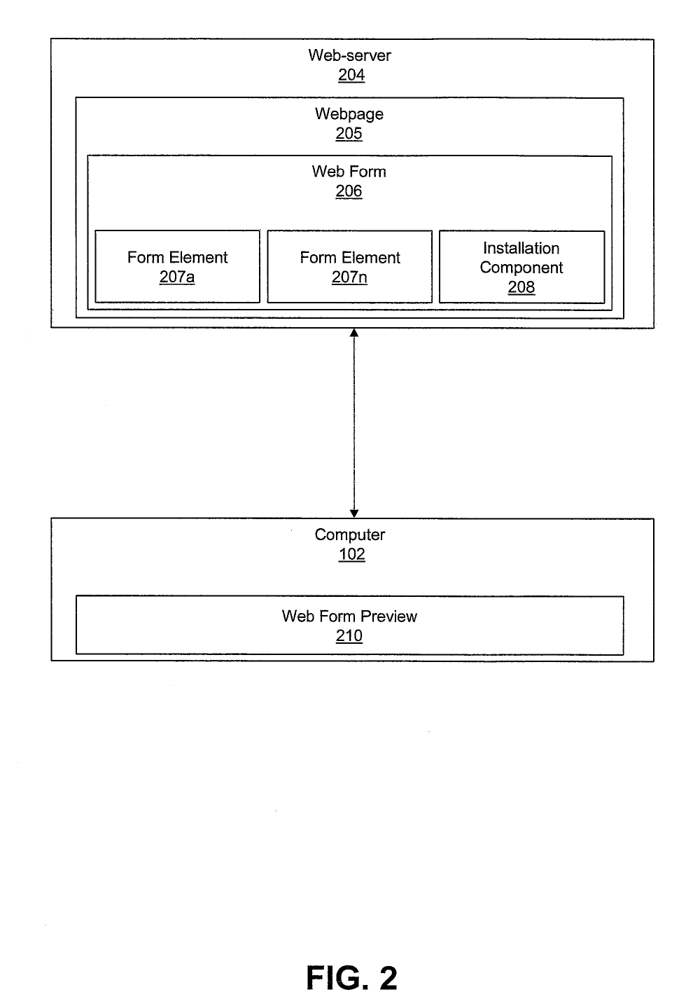

As shown, Computer 102 also comprises system memory 118. System memory 118 also comprises web form logic (WFL) 120 for autonomously completing a web form based on preference and conditions established by a user. WFL 120 includes code for implementing the processes described in FIGS. 2-5.

Computer 102 also comprises storage 124, which is connected to system bus 106. Storage 124 includes a web browser 126 that interfaces directly with a Web Form Plug-in (WFP) 128. WFP 128 is a software instance that interfaces with web browser 126. This interfacing may allow WFL 120 to interface directly with web browser 126. WFP may interface with web browser 126 through a plug-in tool, or through logical coding of a programming language (e.g., JavaScript, HTML, Dynamic HTML, HTML with Document Object Model (DOM), Ajax) used by web browser 126. WFP 128 also contains a form preference database 130. Form preference database 130 may contain one or more form preferences 132a-n. Form preferences 132a-n specify settings and conditions established by a user of computer 102 for autonomously completing form elements of a web form. Additionally, form preferences 132a-n may contain identifying information of the user (e.g., first name, last name, home address, passwords), or information of a preferred layout or view of a web form. In one embodiment, computer 102 is able to utilize WFL 120 to autonomously analyze and complete a web form by implementing form preferences 132a-n, as described in greater detail below in FIGS. 2-5. In an alternate embodiment, a web-server (e.g., web-server 204, FIG. 2) may contain WFL 120.

As illustrated and described herein, computer 102 may be a computer system or server having the required hardware components and programmed with WFL 120, executing on the processor to provide the functionality of the invention. However, computer 102 may also be a device that is specifically designed to include the functionality of WFL 120, as described herein. The hardware elements depicted in computer 102 are not intended to be exhaustive, but rather are representative to highlight essential components required by and/or utilized to implement the present invention. For instance, computer 102 may include alternate memory storage devices such as magnetic cassettes, Digital Versatile Disks (DVDs), Bernoulli cartridges, and the like. These alternate configurations of components and other variations are intended to be within the spirit and scope of the present invention.

With reference now to FIG. 2, there is illustrated an exemplary system for autonomously completing a web form based on preferences and conditions established by a user, in accordance with one embodiment of the invention. The illustrative embodiment is described from the perspective of the WFL 120 receiving a web form 206 from a web-server 204a-n and autonomously completing the web form 206 based on one or more form preferences (e.g., form preferences 132a-n, FIG. 1) stored within a form preference database (e.g., form preference database 130, FIG. 1) of computer 102. Web-server 204a-n may be any remote computing terminal configured to transmit and receive data from computer 102.

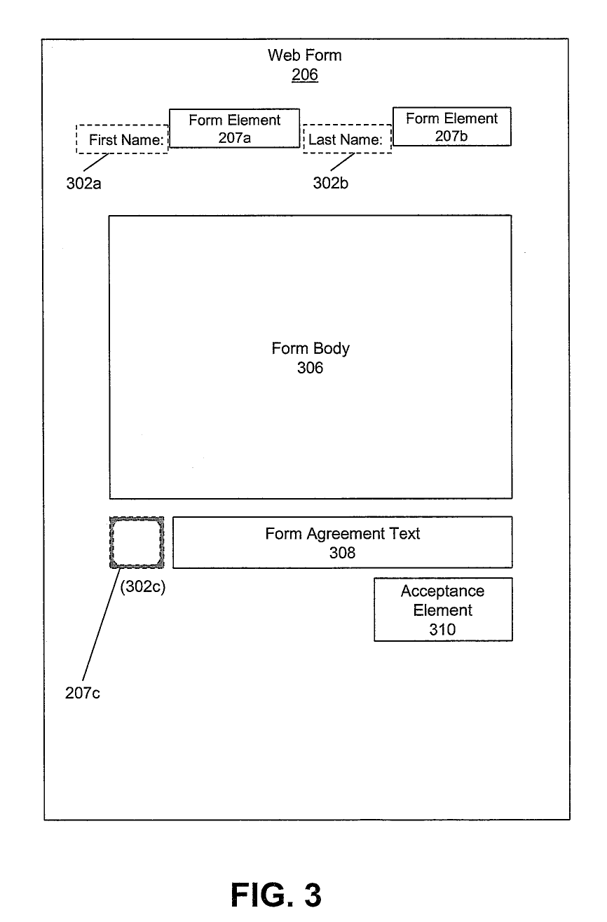

Web form 206 may contain one or more form elements 207a-n. A form element 207a-n (e.g., a check box, radio button, drop-down list, text field) is a query portion of the web form 206 which may require the user to insert data (e.g., last name, address, credit card number) or tender a selection or a response. A form element may also contain an identifier (e.g., identifier 302a-n, FIG. 3). An identifier is an identification label used to identify the type of data requested. The identifier may be visually presented on the web form, or may be embedded in the coding (e.g., hypertext markup language (HTML)) of the web form 207. Alternatively, the identifier may be parsed from label, text, or form elements 207a-n of the web form 206. Computer 102 determines the type of data requested by the form element 207a-n and searches the form preferences database for a form preference matching the data requested. A form preference may establish substitution data and conditions for inserting the data of a matching identifier for a form element (e.g., when identifier type is “Last Name” AND user is “John”, substitute “Doe”). WFL 120 determines that conditions of a form preference are satisfied for a form element 207a-n, WFL 120 may autonomously update the corresponding form element 207a-n to reflect the data specified by the matching form preference. A form preference may also establish conditions for updating a form element from data stored in system memory (e.g., browser cookies), or data obtained through recent actions (e.g., by referencing website history) of the user of computer 102.

When WFL 120 is unable to determine a matching form preference for a form element 207a-n, WFL 120 may prompt the user to manually complete the form element 207a-n. Manually entered data of a form element 207a-n along with currently satisfied criteria (e.g., web form location, current user, OS focus) may be autonomously stored into a new or existing form preference of the form preference database to improve future prediction. In an alternate embodiment, computer 102 may also prompt the user to manually define or update a form preference for the selected form element, instead of manually entering the data. By manually defining a form preference, the user may establish additional criteria of the form preference (e.g., when identifier type is “Login Name” AND website is “IBM”, substitute “johndoe”). A newly created form preference may be utilized by the logic to insert intended information in form elements 207a-n for the current session, and for future sessions.

WFL 120 may also prepare a preview of the web form (e.g., web form preview 210). A preview may display matching form preferences inserted to, or selected of, form elements 207a-n. WFL 120 may prompt the user to tender approval of the suggested changes of the preview before WFL 120 will insert the matching form preference data in corresponding form elements 207a-n of the web form 206. WFL 120 may also determine a confidence level of the insertions made to form elements 207a-n. The confidence level is a value assigned to the overall substitutions made by WFL 120 of the preview. The confidence level may be calculated based on user defined ratings, historical acceptance data of preview web forms, historical confidence levels of a form preference. The confidence level may be displayed to the user, or may be a value utilized by WFL 120 in making intelligent substitutions. When WFL 120 determines that a user has rejected the preview, WFL 120 may prompt the user to manually enter data into one or more form elements 207a-n. In an alternate embodiment, a user may select accept a preview and manually change data of one or more form elements 207a-n. WFL 120 may monitor user made changes of form elements 207a-n, and update corresponding form preferences. WFL 120 may increase or decrease future confidence ratings based on user rejections and acceptances of previews. In an alternate embodiment, WFL 120 may prompt the user to manually define a unique form preference for one or more form elements 207a-n.

WFL 120 may also determine if the web form 206 contains an acceptance element (e.g., acceptance element 310, FIG. 3) by reading the contents of the web form 206. An acceptance element is a submission acceptance link (e.g., a “Submit” button or a hyperlink) of the web form 206, which is selected by the user to complete a web form 206. After inserting form preferences data in form elements 207a-n of a web form 206, WFL 120 may autonomously move a cursor or change the focus on a display (e.g., display 108) of computer 102 to a specific area or to an acceptance element of the web form 206. In one embodiment, changing the focus and moving the cursor over an acceptance element may assist the user by reducing the time needed to locate the acceptance element after WFL 120 has inserted form preference data into form elements 207a-n of the web form 206. In an alternative embodiment, a form preference may contain data pertaining to view settings (e.g., zoom level, column width, window orientation) of a web form 206.

WFL 120 may additionally determine when web form 206 contains an installation component 208. Installation component 208 is a software component for interfacing or displaying data of a web-server 204 on computer 102. Upon detecting that a web form 206 does contain installation component 208, WFL 120 may determine if a form preference has been established that specifies preferences for an installation components 208. A form preference may allow WFL 120 to autonomously install or reject installation of an installation component 208. In response to determining that a form preference has not been established for a specific installation component 208, WFL 120 may prompt the user to manually define a unique form preference for installation component 208. After determining that the form preference database does contain a form preference (e.g., specifying an autonomous install for installation component 208), WFL 120 may autonomously install the installation component 208 without interaction by the user.

With reference now to FIG. 3, there is illustrated a block diagram of an exemplary user interface of a web form. Web form 206 contains identifiers 302a-c corresponding to form elements 207a-c. Identifiers 302a-b are specified on the viewable content of web form 206. Identifier 302c is not displayed in the visible display of web form 206. Identifier 302c may be identified in HTML code of web form 206. WFL 120 determines the form elements 207a-b to be data fields corresponding to a “first name” and a “last name” respectively. Similarly, WFL 120 determines form element 207c to be a check box and requiring user agreement to continue. Form body 306 is the main content of the form and may specify disclaimers or license agreements of interest to the user. Form body 306 may contain text, graphics, or multimedia content. Form agreement text 308 is the agreement content of the form and may contain text listing agreement by the user to agree to certain conditions of the body.

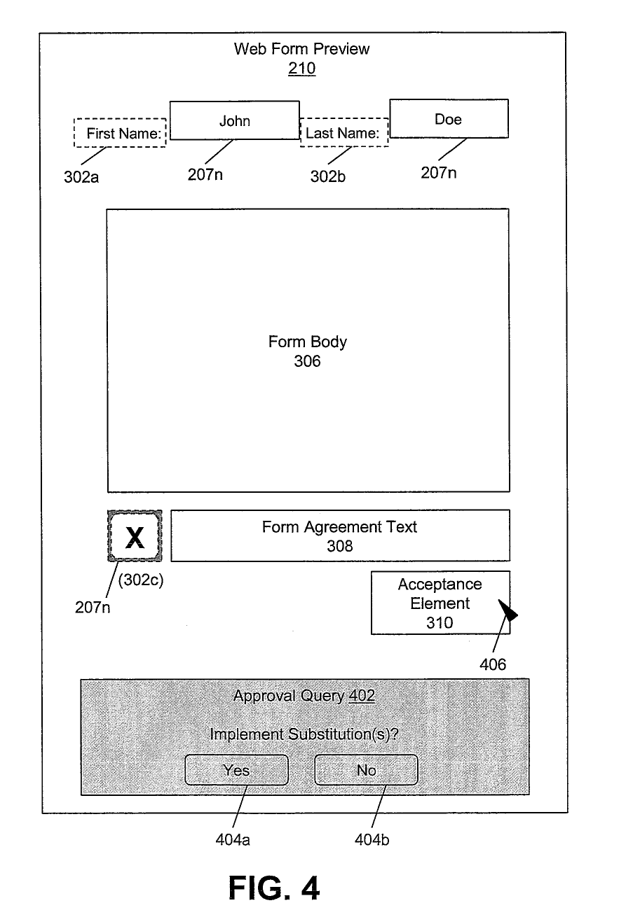

With reference now to FIG. 4, there is illustrated a block diagram of an exemplary user interface presenting a web form preview. Web form preview 210 contains identifiers 302a-c corresponding to form elements 207a-c. Identifiers 302a-b are specified on the viewable content of the web form 206. Identifier 302c is not displayed in the viewable portion of web form preview 206, and may be identified in HTML coding of web form preview 206. WFL 120 has determined the form elements 207a-b to be data fields corresponding to a “first name” and a “last name” respectively, and has autonomously inserted “John” and “Doe”, respectively. Similarly, WFL 120 has determined form element 207c to be a check box and requiring user agreement to continue, and has selected form element 207c. Form body 306 is the main content of the form and may specify disclaimers or license agreements of interest to the user. Form body 306 may contain text, graphics, or multimedia content. Form agreement text 308 is the agreement content of the form and may contain text listing agreement by the user to agree to certain conditions of the body. Approval query 402 instructs the user to select an acceptance box 404a-b confirming their acceptance or rejection of the content inserted in form elements 207a-c. Cursor 406 is positioned over acceptance element 310. By selecting acceptance element 310, a user accepts the data filled in form elements 207a-c by WFL 120.

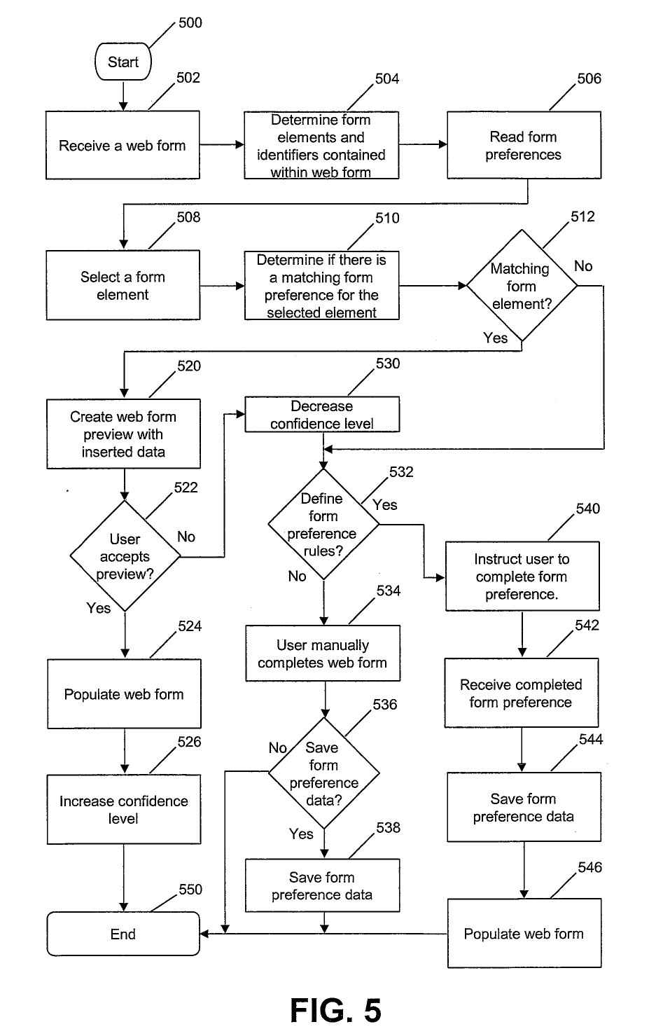

With reference now to FIG. 5, there is provided a high-level logical flowchart of an exemplary method for autonomously completing a web form. After initiator block 500, the process moves to block 502 which illustrates the computer receiving a web form from a web-server (block 502). WFL may then determine form elements and identifiers contained within the received web form (block 504). WFL may then read form preferences stored in a form preference database of the computer (block 506). WFL then selects one or more form element(s) (block 508), and determines if there is/are matching form preference(s) containing data that should be inserted in the selected form element(s) (block 510). Upon determining that the form preference database contains a matching form element (block 512), WFL creates a web form preview (block 520). For the web form preview, WFL inserts the data of the matching form preferences in to the selected form element(s) of the web form preview. WFL may then prompt the user to accept or reject the web form preview (block 522). Upon determining that the user of WFL has accepted the web form preview, WFL populates the web form by inserting the data of the matching form preferences in to the selected form element(s) of the web form (block 524). WFL may then increase the confidence level of the matching form preferences (block 526). The process then ends at terminator block 550.

When WFL determines that the user of the computer has rejected the web form preview, WFL decreases the confidence level of the matching form preferences (block 530). The process then moves to block 532 where WFL prompts the user to define form preference rules for the web form. Additionally, when WFL determines that the form preference database does not contain matching form elements for the selected web form, the process continues to block 532.

When WFL determines that the user of the computer has opted against defining form preference rules for the web form (block 532), WFL instructs the user to manually complete the web form (block 534). After the user has manually completed the web form, WFL may prompt the user to automatically save form preference data for the manually completed web form (block 536). After determining that the user has declined to save form preference data (block 536), the process then ends at terminator block 550. When WFL determines that the user has elected to save the form preference data, WFL saves the form preference data for the manually completed web form to the form preference database (block 538). The process then ends at terminator block 550.

When WFL determines that the user of the computer has selected to define form preference rules for the web form, the computer instructs the user to complete form preferences for the web form (block 540). After WFL has received a completed form preferences for the web form (block 542), WFL saves the form preferences to the form preference database (block 544). The computer may then populate the web form with the data of the user-created form preferences for the web form (block 546). The process then ends at terminator block 550.

In the flow charts above, one or more of the methods are embodied such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

Although aspects of the present invention have been described with respect to a computer processor and program application/logic, it should be understood that at least some aspects of the present invention may alternatively be implemented as a program product for use with a data storage system or computer system. Programs defining functions of the present invention can be delivered to a data storage system or computer system via a variety of signal-bearing media, which include, without limitation, non-writable storage media (e.g. CD-ROM), writable storage media (e.g. network attached storages, hard disk drive, read/write CD-ROM, optical media), and communication media, such as computer and telephone networks including Ethernet. It should be understood, therefore, that such signal-bearing media, when carrying or encoding computer readable instructions that direct method functions of the present invention, represent alternative embodiments of the present invention. Further, it is understood that the present invention may be implemented by a system having means in the form of hardware, software, or a combination of software and hardware as described herein or their equivalent.

Having thus described the invention of the present application in detail and by reference to illustrative embodiments thereof, it will be apparent that modifications and variations are possible without departing from the scope of the invention defined in the appended claims. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for autonomously completing a web form, the method comprising:
receiving a web form from a web-server, wherein the web form contains one or more form elements;
selecting a form element;
reading an identifier of the selected form element, wherein the identifier specifies an intended content of the form element;
reading a plurality of form preferences from a form preference database;
determining if the form preference database contains a form preference corresponding to the selected identifier,
in response to determining the corresponding form preference, inserting the corresponding form preference to the selected form element.

2. The method of claim 1, further comprising:
in response to determining that the form preference database does not contain the corresponding form preference, prompting the user to manually complete the form element;
in response to the user manually completing the form element, issuing a request to update the form preference database with the data of the manually completed form element; and
in response to the receipt of an authorization for the request, updating the form preference database with the data of the manually completed form element.

3. The method of claim 1, further comprising:
in response to determining that the form preference database does not contain the corresponding form preference, issuing a prompt to manually define a unique form preference for the selected form element;
in response to receiving a unique form preference for the selected form element, updating the form preference database with the unique form preference; and
applying the unique form preference to the selected form element.

4. The method of claim 1, further comprising:
applying the corresponding form preference to a preview web form;
displaying the preview web form;
issuing an approval request of the preview web form; and
in response to receiving acceptance of the approval request of the preview web form, inserting the corresponding form preference to the selected form element.

5. The method of claim 4, further comprising:
in response to applying the corresponding form preference to a preview web form, calculating a confidence level of the corresponding form preference, wherein the confidence level comprises of historical data of the corresponding form preference:
displaying the confidence level of the corresponding form preference;
in response to receiving acceptance of the approval request, increasing the confidence level; and
in response to receiving a rejection of the approval request, decreasing the confidence level.

6. The method of claim 1, further comprising:
in response to applying the corresponding form preference, determining if the web form contains an acceptance element; and
moving a cursor of the computer to the acceptance element.

7. The method of claim 1, further comprising:
determining if the web form contains an installation component;
in response to determining that the web form contains the installation component, determining if the form preference database contains an auto-install preference matching the installation component;
in response to determining that the form preference database does not contain the auto-install preference matching the installation component, prompting the user to manually install the installation component;
requesting approval of the user to automatically install the installation component upon subsequently receiving the web form; and
in response to receiving approval to automatically install the installation component from the user, updating the form preference database with an auto-install.

8. The method of claim 7, further comprising, in response to determining that the form preference database does contain the auto-install preference matching the installation component, installing the installation component.

9. A computer comprising:
a processor;
a memory coupled to the processor;
a transceiver;
processing logic for:
receiving a web form from a web-server, wherein the web form contains one or more form elements;
selecting a form element;
reading an identifier of the selected form element, wherein the identifier specifies an intended content of the form element;
reading a plurality of form preferences from a form preference database;
determining if the form preference database contains a form preference corresponding to the selected identifier; and
in response to determining the corresponding form preference, inserting the corresponding form preference to the selected form element.

10. The computer of claim 9, the processing logic further comprising logic for:
in response to determining that the form preference database does not contain the corresponding form preference, prompting the user to manually complete the form element;
in response to the user manually completing the form element, issuing a request to update the form preference database with the data of the manually completed form element; and
in response to the receipt of an authorization for the request, updating the form preference database with the data of the manually completed form element.

11. The computer of claim 9, the processing logic further comprising logic for:
in response to determining that the form preference database does not contain the corresponding form preference, issuing a prompt to manually define a unique form preference for the selected form element;
in response to receiving a unique form preference for the selected form element, updating the form preference database with the unique form preference; and
applying the unique form preference to the selected form element.

12. The computer of claim 9, the processing logic further comprising logic for:
applying the corresponding form preference to a preview web form;
displaying the preview web form;
issuing an approval request of the preview web form; and
in response to receiving acceptance of the approval request of the preview web form, inserting the corresponding form preference to the selected form element.

13. The computer of claim 12, the processing logic further comprising logic for:
in response to applying the corresponding form preference to a preview web form, calculating a confidence level of the corresponding form preference, wherein the confidence level comprises of historical data of the corresponding form preference:
displaying the confidence level of the corresponding form preference;
in response to receiving acceptance of the approval request, increasing the confidence level; and
in response to receiving a rejection of the approval request, decreasing the confidence level.

14. The computer of claim 9, the processing logic further comprising logic for:
in response to applying the corresponding form preference, determining if the web form contains an acceptance element; and
moving a cursor of the computer to the acceptance element.

15. The computer of claim 9, the processing logic further comprising logic for:
determining if the web form contains an installation component;
in response to determining that the web form contains the installation component, determining if the form preference database contains an auto-install preference matching the installation component;
in response to determining that the form preference database does not contain the auto-install preference matching the installation component, prompting the user to manually install the installation component;
requesting approval of the user to automatically install the installation component upon subsequently receiving the web form;
in response to receiving approval to automatically install the installation component from the user, updating the form preference database with an auto-install; and
in response to determining that the form preference database does contain the auto-install preference matching the installation component, installing the installation component.

16. A computer-readable medium having a plurality of instructions embodied therein, wherein the plurality of instructions, when executed by a processing device, allows a machine to:
receive a web form from a web-server, wherein the web form contains one or more form elements;
select a form element;
read an identifier of the selected form element, wherein the identifier specifies an intended content of the form element;
read a plurality of form preferences from a form preference database;
determine if the form preference database contains a form preference corresponding to the selected identifier; and
in response to determining a corresponding form preference, insert the corresponding form preference to the selected form element.

17. The computer-readable medium of claim 16, the plurality of instructions further comprising instructions for enabling the machine to:
in response to determining that the form preference database does not contain the corresponding form preference, issue a prompt to manually define a unique form preference for the selected form element;
in response to receiving a unique form preference for the selected form element, update the form preference database with unique form preference;
apply the unique form preference to the selected form element;
in response to the user declining to manually define the unique form preference for the selected form element, prompt the user to manually complete the form element;
in response to the user manually completing the form element, issue a request to update the form preference database with the data of the manually completed form element; and
in response to the receipt of an authorization for the request, update the form preference database with the data of the manually completed form element.

18. The computer-readable medium of claim 16, the plurality of instructions further comprising instructions for enabling the machine to:
apply the corresponding form preference to a preview web form;
display the preview web form;
in response to applying the corresponding form preference to a preview web form, determine a confidence level of the corresponding form preference, wherein the confidence level comprises of historical data of the corresponding form preference;
display the confidence level of the corresponding form preference;
issue an approval request of the preview web form;
in response to receiving acceptance of the approval request of the preview web form, insert the corresponding form preference to the selected form element and increase the confidence level; and
in response to receiving a rejection of the approval request, decrease the confidence level.

19. The computer-readable medium of claim 16, the plurality of instructions further comprising instructions for enabling the machine to:
in response to applying the corresponding form preference, determine if the web form contains an acceptance element; and
move a cursor of the computer to the acceptance element.

20. The computer-readable medium of claim 16, the plurality of instructions further comprising instructions for enabling the machine to:
determine if the web form contains an installation component;
in response to determining that the web form contains the installation component, determine if the form preference database contains an auto-install preference matching the installation component;
in response to determining that the form preference database does not contain the auto-install preference matching the installation component, prompt the user to manually install the installation component;
request approval of the user to automatically install the installation component upon subsequently receiving the web form;
in response to receiving approval to automatically install the installation component from the user, update the form preference database with an auto-install; and
in response to determining that the form preference database does contain the auto-install preference matching the installation component, install the installation component.
